(19) United States
(12) Patent Application Publication
(10) Pub. No.: US 2025/0102330 A1
(43) Pub. Date: Mar. 27, 2025

(54) Incremental magnetic encoder

(71) Applicant: THALES, Meudon (FR)

(72) Inventors: Mathieu BESNARD, MERIGNAC (FR); Noémie DUPHIL, MERIGNAC (FR)

(21) Appl. No.: 18/894,100

(22) Filed: Sep. 24, 2024

(30) Foreign Application Priority Data
Sep. 26, 2023 (FR) 2310218

(51) Int. Cl. G01D 5/245

(52) U.S. Cl. CPC G01D 5/2451

(57) ABSTRACT

The present invention relates to an incremental magnetic encoder (10) defining an encoder axis (X) and comprising a fixed body and a movable body.

One of the bodies, called the first body (21), comprises a first support (33) comprising N arranged magnetic elements.

The other body, called second body (22), comprises:
a second support (41) comprising K*M magnetic elements arranged inhomogeneously along the direction of encoding (C1, C2) opposite the N magnetic elements, the K*M magnetic elements forming M groups of K magnetic elements, initial elements of the M different groups being spaced apart along the direction of encoding (C1, C2) by a homogeneous pitch P1, the K−1 magnetic elements of each group being spaced apart from the initial magnetic element of said group by variable pitches Pi;
at least one magnetic detector arranged opposite the first support (33).

### FIELD OF THE INVENTION

The present invention relates to an incremental magnetic encoder.

More particularly, the present invention relates to an encoder apt to supply binary logic signals representing increments of relative position of two elements of the encoder, the two elements being movable with respect to each other. Advantageously, such an encoder can be used in the aeronautical field, e.g. in an aircraft cockpit.

Typically, in an application for aeronautical equipment, it is possible to use an angular and/or linear encoder to indicate to an automatic pilot computer, an altitude or speed setpoint the operator chooses by actuating a control button of the encoder. The reliability of the encoder and the information the encoder delivers are then an essential element of the encoder. The typical requirement for an aeronautical encoder can comprise one or a plurality of the following elements: compactness, ability to perform multi-turns in rotation and/or linear travel, incrementing and notching ability, etc. To be certified, the aeronautical encoder should also be able to meet high DALs (Design Assurance Level), particularly the DAL A.

More particularly, with regard to compactness, an encoder typically has a control button with a diameter between 10 and 100 mm and a length between 5 and 50 mm (typically Ø 16 mm×lg 16 mm) and a body with a diameter between 10 and 100 mm and a length between 5 and 100 mm (typically Ø 25 mm×lg 50 mm) hidden behind the attachment panel or attached in front of said panel. In the latter case, the button includes the encoder body which is attached to the panel and makes it possible to be placed around or slightly overlapping a monitor or a screen.

With regard to incrementing capacity, each switching by a notch (or pitch) is an increment of one unit of counting the rotation or the translation. The angular or linear resolution is defined by the pitch (or notch). The number of pitches per revolution is on the order of 1 to 32 pitches (typically 12 pitches). The number of pitches in translation is from e.g. from 1 to 10 notches (typically 1 notch in each direction for obtaining a push/pull button with a stable state between the two notches).

To detect the direction of the movement in rotation and/or translation, the encoder generally has at least two detectors (for rotation and/or for translation) physically offset from each other (typically an odd number of quarter pitches). The two detectors can be used for the encoding of the movement in rotation and/or translation, over two bits. Thus, the encoding gives the following successive values: 00, 01, 11, 10 when the encoder rotates and/or translates in one direction and the following successive values: 00, 10, 11, 01 when the encoder rotates and/or translates in the other direction. It is thus possible to determine not only the appearance of an increment in rotation and/or translation (change of state of one of the bits) but also the direction of rotation and/or in translation (by comparison between a detected state and the immediately preceding state).

With regard to the notching ability of the encoders, the switching of an encoded notch usually results in tactile feedback that an operator should feel when handling the device. The angular notching torque can be e.g. on the order of 1 to 700 mN·m (typically 12 mN·m) and the linear notching force on the order of 0.5 to 20 N (typically 6 N).

The most complex encoders have rotational and translational encoding and notching. The rotational encoding and notching should not be blocked by the translational encoding and notching. In such case, rotational and translational detection and notching should be able to be used simultaneously without any loss of performance. For example, for entering a speed, the pilot will have to simultaneously push the encoder button and turn the button to the chosen value.

Finally, in certain cases, to secure the encoder and in particular to guarantee the DAL (e.g. DAL A) thereof, the detection (or encoding) functions are at least duplicated.

### BACKGROUND

To meet the above-mentioned needs, the encoders used in aeronautical applications are often based on opto-mechanical (optical detection and mechanical notching) or electromechanical (detection by electrical contact and mechanical notching) and sometimes magneto-mechanical (magnetic detection and mechanical notching) or opto-magnetic or even purely magnetic solutions.

For example, opto-mechanical encoders are described in the documents FR 2937129 and FR 2954491. According to said documents, the rotational and/or translational detection (encoding) is performed by an optical encoder while the maintenance in a stable position (notching) is ensured mechanically by at least one ball pressurized by a spring on a ball race (or cam). Even if such latest innovations meet the needs described above and aim to simplify the production thereof, the opto-mechanical and electromechanical encoders remain complex assemblies consisting of numerous high-precision parts.

More generally, current mechanical notching solutions generate friction (example: ball against cam) and wear, which limits the service life of the device, especially when plastic parts are used. In electromechanical encoders, detection and notching are sometimes linked by at least one common mechanical part which serves both for the click and the detection via an electrical contact. The latter is often exposed to the risk of wear, of “fretting corrosion” and limits the service life of the device. In addition, in opto-mechanical and sometimes electromechanical devices, the detection and the notching are uncoupled, i.e. same result from different solutions and/or phenomena and are quite distant physically. Such uncoupling increases the number of parts and consequently the risk of misalignment between detection and notching. In the case of complex and secure encoders, the number of parts is even greater. In such case, to ensure good performance and reliability, the current complex encoders require high precision parts which are more expensive.

Document FR 2370350 is also known, which describes a rotary magnetic encoder with movable magnets wherein the notching and the encoding result from the magnetic phenomenon. However, the encoder of said document is only rotary and uses moving magnets which are exposed to risks of friction and jamming.

In summary, electromechanical solutions present the highest risk of fatigue both in terms of notching and encoding because such solutions generate the most friction. Moreover, electrical encoding is exposed to fretting corrosion. Such drawbacks reduce the reliability and limit the service-life of the device.

The opto-mechanical and magneto-mechanical solutions do not address the risk of fatigue at the mechanical notching.

Opto-magnetic solutions use different contactless phenomena. Such solutions are bulkier if it is desired to make a more complex encoder (e.g.: rotary encoder with “push/pull”) and secure.

Finally, known purely magnetic solutions do not meet all of the aforementioned needs and still have significant overall size.

### SUMMARY OF THE INVENTION

The goal of the present invention is to propose an incremental encoder satisfying all the aforementioned needs (compactness, ability to perform multi-turns in rotation and/or a linear travel, incrementing and notching ability, etc.), while having notching and detection functions (encoding) with no friction and no wear, a limited number of parts, simplified assembly and reduced risk of jamming and shifting. In addition, the incremental encoder according to the invention can be made particularly compact. Furthermore, it is possible to adjust the notching force provided by the encoder in a particularly simple and precise way.

To this end, the invention relates to an incremental magnetic encoder defining an encoder axis and comprising a fixed body and a body movable with respect to the fixed body along at least one direction of encoding;
one of the bodies, called first body, comprising:
   a first support comprising N magnetic elements arranged along the direction of encoding according to a homogeneous pitch PO and defining a magnetic alternation along said direction;
the other body, called second body, comprising:
   a second medium comprising K*M magnetic elements arranged inhomogeneously along the direction of encoding opposite the N magnetic elements, the K*M magnetic elements forming M groups of K magnetic elements, each of the M groups comprising an initial magnetic element of said group, the initial elements of the M different groups being spaced apart along the direction of encoding by a homogeneous pitch P1, the K−1 magnetic elements of each group being spaced from the initial magnetic element of the group by variable pitches Pi looped back over a predetermined extent along the direction of encoding;
   at least one magnetic detector arranged opposite the first support and configured for quantifying each movement of the movable body along the direction of encoding.

Provided with such characteristics, the encoder according to the invention can be used for implementing an encoding along one of the chosen directions, e.g. amongst the translation direction and the rotation direction, while ensuring notching along the same direction. According to the invention, the encoding and the notching are created by the same magnetic effect between the movable body and the fixed body.

Thereby, the arrangement of the two bodies can be chosen so as to minimize the mechanical contact. For example, the elements detailed hereinabove of the fixed body and of the movable body have no contact with each other. Thereby, such elements work without friction and without premature mechanical wear. The above guarantees the reliability of the use of the encoder and considerably extends the service life thereof even when plastic parts are used. Moreover, such elements are limited in number, which makes it possible to arrange same easily within the corresponding bodies. More particularly, the number of magnetic elements on the second body can be reduced compared to same on the first body, while ensuring a number of notches and a necessary force. As a result, the encoder can be made more compact and the number of parts necessary for the operation thereof can be reduced.

The above makes the mounting of the button particularly easy and reduces the risks of jamming and of shifting of different parts from one another.

According to other advantageous aspects of the invention, the encoder comprises one or a plurality of the following features, taken individually or according to all technically possible combinations:
the second body comprises M magnetic detectors, each magnetic detector being configured to quantify each movement of the movable body along the direction of encoding;
the or each magnetic detector is arranged on the second support in a gap formed between two groups of K magnetic elements;
the M groups of K magnetic elements define the same variable pitches Pi;
each variable pitch Pi is defined according to the following relation:

$$P i = {k}_{i} \frac{L}{N}$$

where
L is said predetermined range;
kᵢ is a natural number chosen to be different for each variable pitch.
within each group, the magnetic elements are evenly spaced from each other;
at least one magnetic element of one of the M groups of K magnetic elements is arranged between two magnetic elements of another group of K magnetic elements;
the second body is the fixed body;
the direction of encoding corresponds to a translation along the encoder axis or to a rotation around the encoder axis;
the movable body is mobile with respect to the fixed body furthermore along an additional direction of encoding perpendicular to said direction of encoding;
the first body and the second body comprise a plurality of additional magnetic elements arranged in the additional direction of encoding on the two bodies at least partially facing each other.

### BRIEF DESCRIPTION OF FIGURES

The features and advantages of the invention will appear upon reading the following description, given only as an example, but not limited to, and making reference to the enclosed drawings, wherein:

FIG. 1 is a schematic perspective view of a magnetic encoder according to a first embodiment of the invention, the encoder being partially attached behind a panel forming an instrument panel;

FIG. 2 is an exploded perspective view of the encoder shown in FIG. 1;

FIG. 3 is a partial section view along the longitudinal plane III shown in FIG. 1;

FIG. 4 is a perspective view of the functional internal elements of the movable body shown in FIG. 1, said elements comprising in particular a translation ring and a rotation ring;

FIG. 5 is a partial section view of the translation ring shown in FIG. 4 with a translation ring of the fixed body;

FIG. 6 are two diagrams illustrating different options for arranging magnetic elements on the translation ring shown in FIG. 4;

FIG. 7 is a sectional view of the rotation ring shown in FIG. 4 with a rotation ring of the fixed body;

FIG. 8 two diagrams illustrating different of layout options of magnetic elements on the rotation ring shown in FIG. 4;

FIG. 9 is a view similar to the view shown in FIG. 7, illustrating another example of embodiment of the fixed body;

FIG. 10 is a diagram illustrating the notching forces and the signals of two detectors obtained in the encoder shown in FIG. 1;

FIG. 11 is a schematic perspective view of a magnetic encoder according to a second embodiment of the invention, the encoder being partially attached behind a panel forming an instrument panel; and

FIG. 12 is a perspective view of the functional internal elements of the movable body shown in FIG. 11.

### DETAILED DESCRIPTION OF THE INVENTION

### First Embodiment

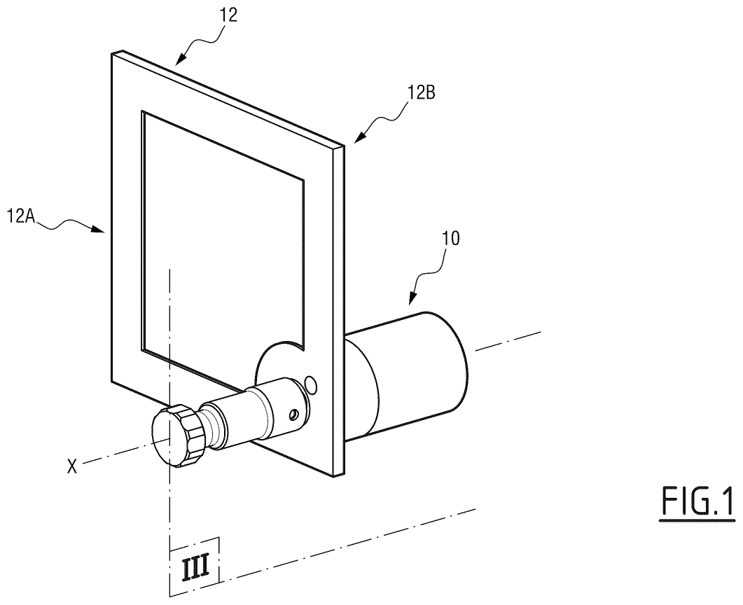

FIG. 1 shows an incremental magnetic encoder 10 according to a first embodiment of the invention. Preferentially, the encoder 10 is mounted in a cockpit used for piloting an aircraft.

“Aircraft” means any flying device, such as e.g. an airplane, a helicopter or a drone. Such an aircraft can be piloted directly from the cockpit. In such case, the cockpit is advantageously arranged inside the aircraft. According to another example of embodiment, such an aircraft is controlled remotely. In such a case, the cockpit is arranged at a distance from the aircraft and has e.g. a ground station. In any case, the aircraft is configured for being piloted by an operator, e.g. by a pilot, from the cockpit located inside the aircraft.

According to the invention, the encoder 10 is used by the operator for controlling at least one avionic function. For example, such an encoder 10 can be used by the operator for controlling an avionic system and forms part of a control system of such an avionic system. In a variant, the encoder 10 is part of a control system for a plurality of avionic systems. For example, the encoder 10 according to the invention is part of a system called “Flight Control Unit” (FCU) or “Integrated Standby Instrument System” (ISIS) or “Closer Control Device” (CCD) or “Keyboard Cursor Control Device” (KCCD), etc.

In the example shown in FIG. 1, the encoder 10 is partially integrated into the panel 12. The panel 12 forms e.g. an instrument panel of the cockpit of the aircraft for one of the aforementioned control systems. In the example shown in FIG. 1, the encoder 10 is arranged partially in the front part 12A of the panel 12 and partially in the rear part 12B of the panel 12. More particularly, in the example shown in FIG. 1, the front part 12A of the panel 12 is oriented towards the operator while the rear part 12B of the panel is oriented towards the inner part of the instrument panel. Of course, other examples of arrangement of the encoder 10 with respect to the panel 12 or with respect to any other means of attachment are possible as well.

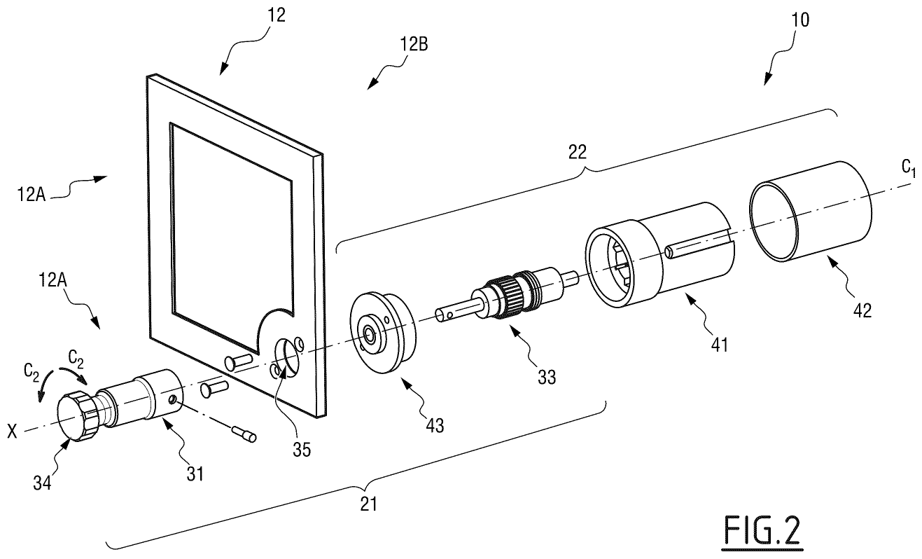

With reference to FIG. 2, the encoder 10 comprises a movable body 21, also called, in the example shown in the figure, first body, and a fixed body 22, also called, in the example shown in the figure, second body.

The movable body 21 comprises a button 31 and a rotor 33.

The button 31 protrudes with respect to the panel 12 and is arranged in the front part 12A of the panel 12. The button 31 is movable in translation along an encoder axis X and in rotation about the encoder axis X. In particular, the button 31 is movable along a first direction of encoding C1 which corresponds in the present example to the direction of translation along the axis X of the encoder and a second direction of encoding C2 which corresponds in the present example to the direction of rotation about the axis of encoding X. Advantageously, the button 31 is movable in each direction along each direction of encoding C1, C2. In particular, in the direction of rotation, the button 31 is movable in rotation clockwise and anti-clockwise and, along the direction of translation, the button 31 being movable in the direction towards the instrument panel and towards the operator. Advantageously, the button 31 defines in particular, a button surface 34 which is intended for being oriented towards the operator. The surface 34 thus represents an external surface of the button 31 which is visible to the operator and can be gripped by the operator.

The rotor 33 extends along the axis X of the encoder so as to form on one of the ends thereof, a link rigidly attached to the button 31. Thereby, just like the button 31, the rotor 33 is movable along the first direction of encoding C1 and along the second direction of encoding C2, in each aforementioned direction of movement. The rotor 33 forms a support where same receives functional internal elements of the movable body 21 which will be explained thereafter in greater detail.

The fixed body 22 comprises a support 41, a cover 42 and a flange 43.

The flange 43 is e.g. arranged in a through hole 35 of the panel 12 and supports the button 31 and the rotor 33. In the example shown in FIG. 2, the flange 43 is attached to the panel 12 while remaining in the rear part 12B of the latter, e.g. by using screws accessible from the front part 12B of the panel 12.

The support 41 receives functional internal elements of the fixed body 22 which are intended for cooperating with the functional internal elements of the movable body 21 as will be explained thereafter in greater detail. More particularly, and as will be apparent thereafter, the functional internal elements of the fixed body 22 are held by the support 41 at a distance from same of the movable body 21. To this end, the support 41 is configured for receiving at least partially, the rotor 33 with the functional internal elements of the movable body 21 borne by the rotor 33.

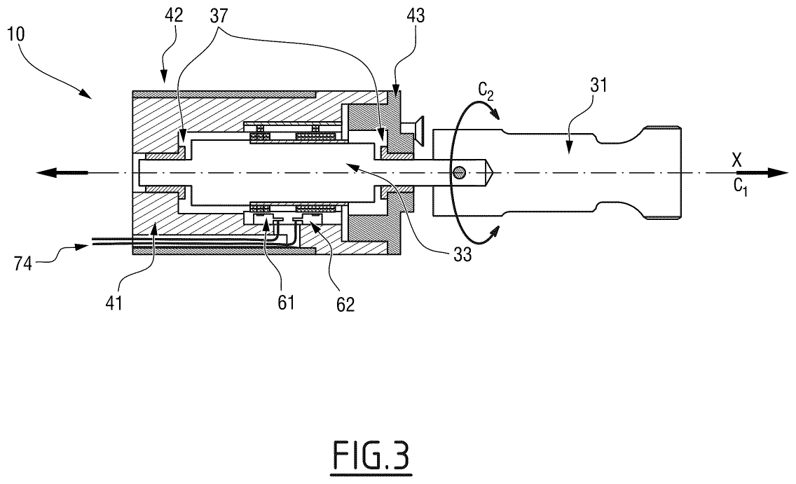

The support 41 is e.g. linked to the movable body 21 via a link movable along each direction of encoding. Such link can e.g. be formed at each end of the rotor 33 and have plain bearings, e.g. polymer bearings or sintered bronze bearings. Such bearings are preferentially flanged in order to serve as a mechanical stop. According to another example, the bearings are rolling element bearings such as ball sleeves. FIG. 3 shows in particular the bearings 37 linking the rotor 33 to the second body 22. In the example shown in said figure, the bearings 37 link one end of the rotor 33 directly to the support 41 and the other end of the rotor 33 to the support 41 via the flange 43. In said example, the flange 43 is configured for cooperating with the support 41 in order to attach the support to the panel 12.

The cover 42 is intended for protecting all the components of the encoder 10 which are arranged in the rear part 12B of the panel 12.

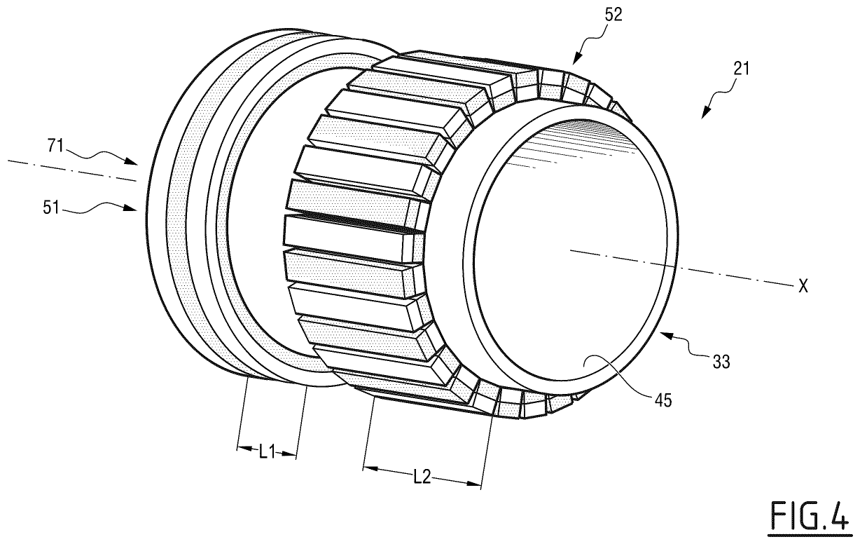

In the example shown in FIG. 4 illustrating in greater detail the functional internal elements of the movable body 21, the rotor 33 has e.g. a hollow shaft 45 with a cylindrical shape extending along the axis X of the encoder.

With reference to the FIG. 4, the functional internal elements of the movable body 21 comprise a first ring 51, called translation ring, and a second ring 52, called rotation ring. Each of the rings 51, 52 is attached onto the shaft 45 along the axis X of the encoder and stays spaced from the other ring 51, 52. Furthermore, each of the rings 51, 52 has a magnetic alternation: axial in the case of the translation ring 51 and circumferential in the case of the rotation ring 52.

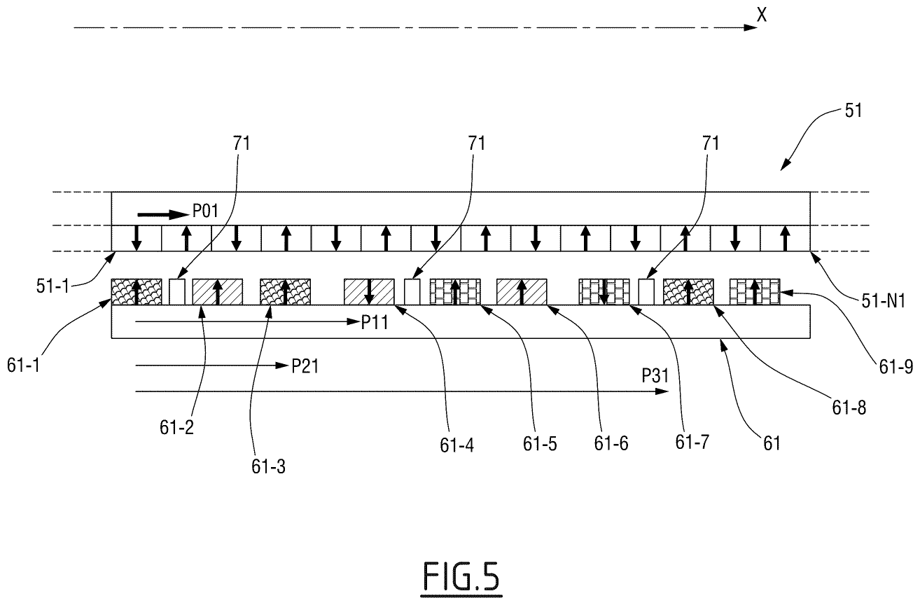

FIG. 5 illustrates, in section, the lower part translation ring 51. Thereby, with reference to the FIG. 5, the translation ring 51 extends along the axis X of the encoder and has N1 elementary rings 51-1 to 51-N1 arranged side by side, e.g. by bonding The number N1 is comprised e.g. between 3 and 20. Each elementary ring 51-1, . . . 51-N1 is e.g. made of a single block or from a plurality of parallelepiped magnets or magnets in the shape of an arc of a circle. Such an elementary magnet can e.g. come from a “polymagnet” or from a “programmable magnet” called Polymagnets®.

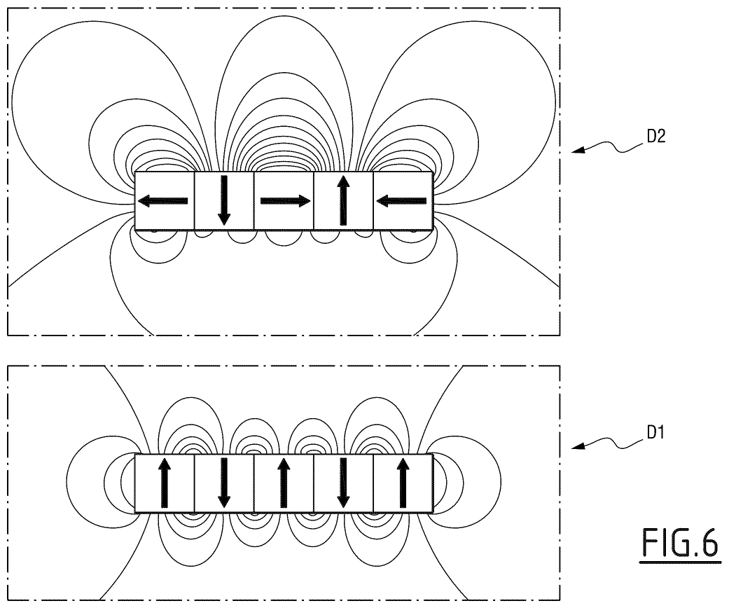

In order to achieve an axial magnetic alternation, in the example shown in FIG. 5, the elementary rings 51-1, . . . , 51-N1 have a radial magnetization and are arranged side by side so that the adjacent rings are magnetized in opposite directions along the radial direction. Such layout of the elementary parts forms a pattern D1 of the magnetic fluxes illustrated in FIG. 6 in the case of five elementary parts.

According to another example of possible arrangement, an axial magnetic alternation is achieved by using a Halbach type arrangement, a diagram D2 of the magnetic fluxes of which is also illustrated in FIG. 6. In particular, according to such a type of layout, the elementary rings are magnetized alternately along the radial and the axial directions. Moreover, the direction of magnetization of each elementary ring is chosen so as to concentrate the magnetic field on the surface of the translation ring 51 facing the functional internal elements of the fixed body 22. In the example of the arrangement shown in FIG. 4, such a magnetic field is concentrated on the outer surface of the translation ring 51.

The translation ring 51 has a width L1 corresponding to the extent thereof along the axis X of the encoder. The width L1 is formed by a sum of the widths of the elementary rings 51-1, . . . , 51-N1 forming the translation ring 51. The width of each elementary piece forms a pitch P01. According to one embodiment, the elementary rings have the same width. In such a case, the translation ring 51 has a homogeneous pitch P01 which can be determined according to the following relation:

$$P 01 = \frac{L 1}{N 1} .$$

In the example of FIG. 5, among the elementary rings 51-1, . . . , 51-N1, the elementary rings 51-2, . . . , 51-N1-1 are arranged between the elementary rings 51-1, 51-N1. The elementary rings 51-2, . . . , 51-N1-1 are then called central rings and the elementary rings 51-1, 51-N1 are called peripheral rings.

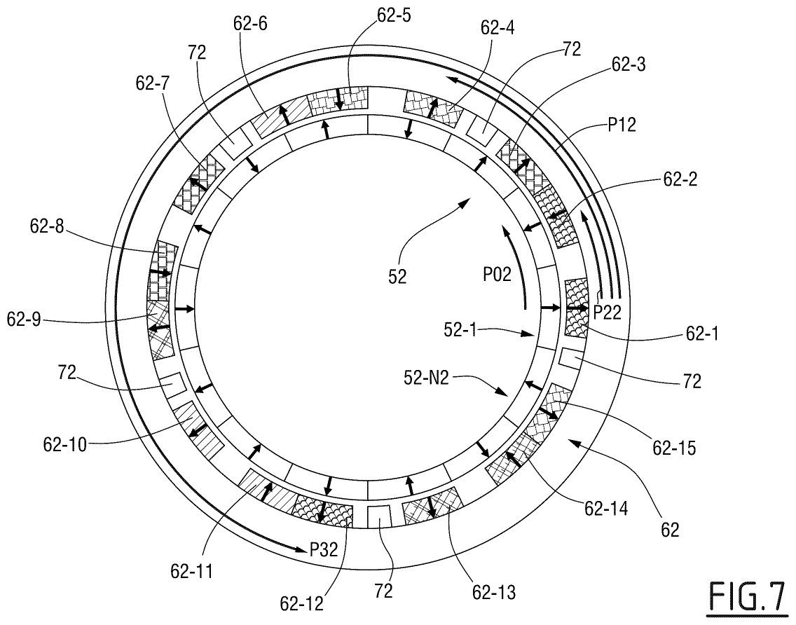

The rotation ring 52 is shown in more detail in FIG. 7. The rotation ring 52 also extends along the axis X of the encoder and has a width L2 (visible on FIG. 4) corresponding to the longitudinal extent thereof. Advantageously, the width L2 is greater than the width L1 of the translation ring 51, in particular when the longitudinal extent of all the elementary parts (explained hereinbelow) are substantially identical. The rotation ring 52 has e.g. the same diameter as the translation ring 51.

The circumferential magnetic alternation of the rotation ring 52 is achieved by a particular layout of a plurality of elementary parts 52-1, . . . , 52-N2 forming the rotation ring 52, each elementary part 52-1, . . . , 52-N2 having e.g. a permanent magnet. Each elementary part 52-1, . . . , 52-N2 can e.g. have a substantially parallelepiped shape which is elongated along the encoder axis X. Such shape can e.g. be slightly curved in order to form an arc of a circle around the encoder axis X.

The elementary parts 52-1, . . . , 52-N2 are arranged next to each other, e.g. by bonding along the circumferential direction. The circumferential extent of each elementary part forms a P02 pitch. Thereof is a homogeneous pitch P02 when all the elementary parts 52-1, . . . , 52-N2 have the same circumferential extent. The pitch can be expressed in angular form as follows:

$$P 02 = \frac{2 π}{N 2} .$$

Like in the case of elementary rings, each elementary part 52-1, . . . , 52-N2 is e.g. made of a single block or from a plurality of parallelepiped magnets or of magnets in the shape of an arc of a circle. Such an elementary part can also come from a “polymagnet” or a “programmable magnet” called Polymagnets®.

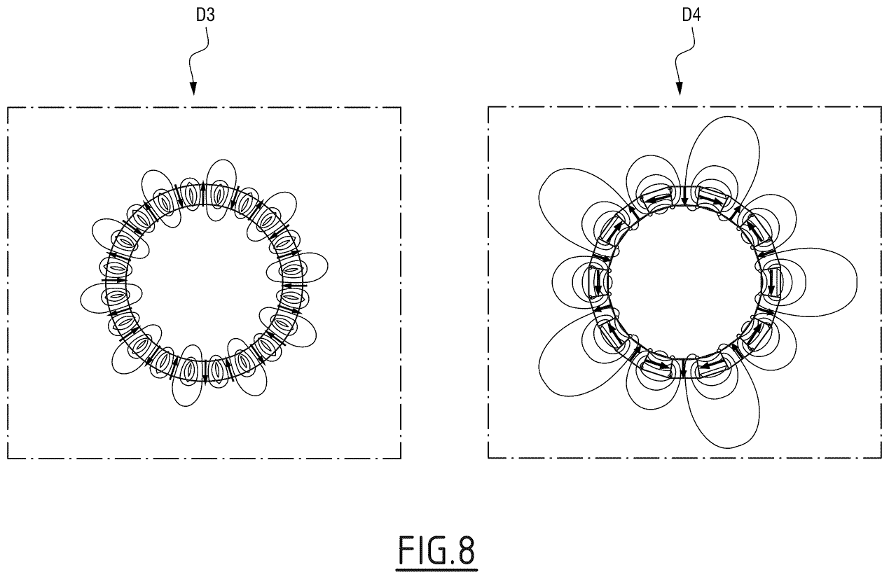

In the example shown in FIG. 7, the elementary parts 52-1, . . . , 52-N2 have a radial magnetization and are arranged side by side so that the adjacent elementary parts are magnetized in opposite directions along the radial direction. Such layout of the elementary parts forms a pattern D3 of the magnetic fluxes illustrated in FIG. 8.

According to another example of possible layout, an axial magnetic alternation is achieved by using a Halbach type arrangement, a diagram D4 of the magnetic fluxes of which is also illustrated in FIG. 8. More particularly, according to such a type of arrangement, the elementary parts 52-1, . . . , 52-N2 are magnetized alternately along the radial and the circumferential directions. Moreover, like in the previous case, the direction of magnetization of each elementary part 52-1, . . . , 52-N2 is chosen so as to concentrate the magnetic field on the surface of the rotation ring 52 facing the functional internal elements of the fixed body 22. In the example of the arrangement shown in FIG. 4, such a magnetic field is concentrated on the outer surface of the rotation ring 52.

The functional internal elements of the fixed body 22 comprise a plurality of magnetic detectors of translation 71 also called first magnetic detectors, a plurality of magnetic rotation detectors 72, also called second magnetic detectors, a translation ring 61 and a rotation ring 62. In the example shown in the figures, the elements 61, 62, 71, 72 are attached to an inner surface of the support 41 (shown in FIG. 2) of the fixed body 22. Furthermore, as mentioned hereinabove, the elements 61, 62, 71, 72 are kept at a distance from the corresponding rings 51 and 52 of the movable body 21.

The elements 61, 71 can be seen in greater detail in FIG. 5.

In particular, the translation ring 61 of the fixed body 22 is arranged around the translation ring 51 of the movable body 21 so that the outer surface of the translation ring 51 of the movable body 21 faces the inner surface of the translation ring 61 of the fixed body 22. Thereof is visible in particular in FIG. 5 which shows a cross-section of the lower part of the two translation rings 51, 61.

Just like the translation ring 51 of the movable body 21, the translation ring 61 of the fixed body 22 extends along the axis X of the encoder and has e.g. the same axial extent L1 or a different extent. For example, said extent may be shorter than L1 or longer than L1. In such a case, it is possible to reach a substantially constant notching force over the entire translation travel. The difference in the axial extent of the translation rings 51, 61 represents the translation travel.

Furthermore, the translation ring 61 of the fixed body 22 comprises K1*M1 elementary rings 61-1 to 61-K1*M1 arranged next to each other, spaced apart and fastened to a common support, e.g. by an adhesive. Each elementary ring 61-1 to 61-K1*M1 is e.g. analogous to the elementary rings 51-1, . . . , 51-N1 explained hereinabove. The elementary rings 61-1 to 61-K1*M1 have e.g., the same extent along the encoder axis X. this extent is, e.g., equal to that of the elementary rings 51-1, . . . , 51-N1 of the movable body 21. Unlike the elementary rings 51-1, . . . , 51-N1 of the movable body 21, the elementary rings 61-1 to 61-K1*M1 of the fixed body 22 are spaced inhomogeneously along the encoder axis X.

The number K1*M1 is advantageously strictly smaller than the number N1. The elementary rings K1*M1 61-1 to 61-K1*M1 form M1 groups of K1 magnetic elements.

The M1 groups are spaced apart along the encoder axis X according to a homogeneous pitch P11. The homogeneous pitch P11 between the groups is measured e.g. between the first elementary rings of the groups, along the encoder axis X. The homogeneous pitch P11 can be determined according to the following relation:

$$P 11 = \frac{L 1}{M 1} .$$

Within each group, the K1-1 elementary rings are spaced from the first ring of the group according to variable pitches Pi1, i corresponding herein to the index of the elementary ring within the corresponding group. The index i is greater than or equal to 2 and less than or equal to K1. The inhomogeneous pitch Pi1 is determined according to the following relation:

$$\begin{matrix}Pi 1 = {k}_{i} * \frac{L 1}{N 1} , & where\end{matrix} ∀ {k}_{i} ∈ {*}^{} , \qquad ∀ i ∈ 〚 2 , K 1 〛$$

where kᵢ is a parameter chosen for each i.

The pitches Pi1 are measured from the first ring of the corresponding group, in a looped manner within the axial extent L1. In other words, when the value j*P11+Pi1 exceeds L1 for a certain i and a certain j for the first time, the corresponding elementary ring is placed at the distance j*P11+Pi1−L1 from an edge of the translation ring 61 (left edge in the example shown in FIG. 5).

In the example shown in FIG. 5, the M1 is equal to 3 and K1 is equal to 3. Thereby, in total, 9 elementary rings 61-1 to 61-9 are arranged on the translation ring 61 of the fixed body 22. In said figure, the elementary rings corresponding to the same group are hatched in the same way. The rings 61-1, 61-3 and 61-8, rings 61-4, 61-6, 61-2 and rings 61-7, 61-9 and 61-5, form the same group of rings. More particularly, the first elementary rings 61-1, 61-4 and 61-7 of said groups are spaced apart by the homogeneous pitch P11. In each group, the second elementary ring is spaced from the first elementary ring by the pitch P21 and the third elementary ring is spaced from the first elementary ring by the pitch P31. In other words, for the first group, the ring 61-3 is spaced from the ring 61-1 by the pitch P21 and the ring 61-8 is spaced from the ring 61-1 by the pitch P31.

Advantageously, the total number of notches obtained by the cooperation between the translation rings 51, 61 is equal to

$$\frac{N 1}{2} * M 1 .$$

The resulting notching pitch is thus calculated as follows:

$$P = \frac{L 1}{\frac{N 1}{2} ⋆ M 1} ,$$

when M1 and N1 are prime to each other (i.e. without a common divider outside 1, e.g. M1=3 and N1=14).

The number of magnetic detectors of translation 71 is advantageously equal to the number M1 of groups of K1 elementary rings. The magnetic detectors of translation 71 are arranged along the axis X, advantageously in gaps formed between different elementary rings. The magnetic detectors of translation 71 serve to quantify the displacement of the translation ring 51 of the movable body 21 along the encoder axis X. In other words, the detectors 71 encode each displacement of the translation ring 51 of the movable body 21 along the encoder axis X by detecting changes in the magnetic flux due to the axial magnetic alternation of the elementary rings forming the translation ring 51. For example, the detectors 71 are offset from each other by the pitch P11, as are the groups of elementary rings.

In the example shown in FIG. 5, a magnetic translation detector 71 is arranged after the first elementary ring of each group of rings.

Each magnetic detector 71 has e.g. a Hall effect sensor or a magnetoresistive sensor or a solenoid. Furthermore, each magnetic detector 71 is connected to an external controller of the encoder 10 by cables 74 visible in FIG. 3.

Just like the rotation ring 52 of the movable body 21, the rotation ring 62 of the fixed body 22 extends along the encoder axis X and has e.g. the same axial extent L2. Furthermore, the rotation ring 62 of the fixed body 22 comprises K2*M2 elementary parts 62-1 to 62-K2 *M2 arranged inhomogeneously along the circumferential direction on a common support forming a ring. Each elementary part 62-1 to 62-K2*M2 is e.g. analogous to the elementary parts 52-1, . . . , 52-N2 explained hereinabove.

The number K2*M2 is advantageously strictly smaller than the number N2.

The K2*M2 elementary parts 62-1 to 62-K2*M2 form M2 groups of K2 elementary parts.

The M2 groups are spaced apart along the circumferential direction according to a homogeneous angular pitch P12. The homogeneous pitch P12 between the groups is measured, e.g. between the first elementary parts of the groups, along the circumferential direction. The homogeneous pitch P12 can be determined by the following relation:

$$P 12 = \frac{2 π}{M 2} .$$

Within each group, the K2-1 elementary parts are spaced from the first piece of the group according to variable angular pitches Pi2, i corresponding herein to the index of the elementary part within the corresponding group. The index i is greater than or equal to 2 and less than or equal to K2. The variable pitch Pi2 is determined according to the following relation:

$$\begin{matrix}Pi 2 = {k}_{i} * \frac{2 π}{N 2} , & where\end{matrix} ∀ {k}_{i} ∈ {*}^{} , \qquad ∀ i ∈ 〚 2 , K 2 〛$$

where kᵢ is a parameter chosen for each i.

The pitches Pi2 are measured in a looped manner along the circumferential direction. In other words, when the value j*P12+Pi2 exceeds 2π for a certain i and a certain j for the first time, the corresponding elementary part is placed at the angle j*P12+Pi2−2π from a reference point of the rotation ring 62.

In the example shown in FIG. 7, M2 is equal to 5 and K2 is equal to 3. Thereby, in total, 15 elementary parts 62-1 to 62-15 are arranged on the rotation ring 62 of the fixed body 22.

In said figure, the elementary parts corresponding to the same group are hatched in the same way. The parts 62-1, 62-2, 62-12, the parts 62-4, 62-5, 62-15, the parts 62-7, 62-8, 62-3, the parts 62-10, 62-11, 62-6 and the parts 62-13, 62-14, 62-9 form the same group of elementary parts. More particularly, the first elementary parts 62-1, 62-4, 62-7, 62-10 and 62-13 are spaced apart by the homogeneous angular pitch P12. In each group, the second elementary part is spaced from the first elementary part by the angular pitch P22 and the third elementary part is spaced from the first elementary part by the angular pitch P32. In other words, for the first group, the part 62-2 is spaced from the part 62-1 by the pitch P22 and the part 62-12 is spaced from the part 62-1 by the pitch P32.

Advantageously, the total number of notches obtained by the cooperation between the rotation rings 52, 62 is equal to

$$\frac{N 2}{2} * M 2 .$$

The angular pitch resulting from notching is thus computed as follows:

$$P = \frac{2 π}{\frac{N 2}{2} ⋆ M 2} ,$$

when M2 and N2 are prime to each other (i.e. without a common divider outside 1).

The number of magnetic rotation detectors 72 is advantageously equal to the number M2 of groups of K2 elementary parts. The magnetic rotation detectors 72 are arranged along the circumferential direction about the encoder axis X, advantageously in gaps formed between different elementary parts. The magnetic detectors of rotation 72 serve to quantify the displacement of the ring 52 about the encoder axis X. In other words, the detectors 72 serve to encode each displacement of the rotation ring 52 of the movable body 21 about the encoder axis X by detecting changes in the magnetic flux due to the axial magnetic alternation of the elementary parts forming the translation ring 51. For example, the detectors 72 are offset from each other by the pitch P12 just like the groups of elementary parts.

In the example shown in FIG. 7, a magnetic rotation detector 72 is arranged before the first elementary part of each group of parts.

As in the preceding case, each magnetic detector 72 has e.g. a Hall effect sensor or a magnetoresistive sensor or a solenoid. Furthermore, each magnetic detector 72 is connected to an external controller of the encoder 10 by in the cables 74.

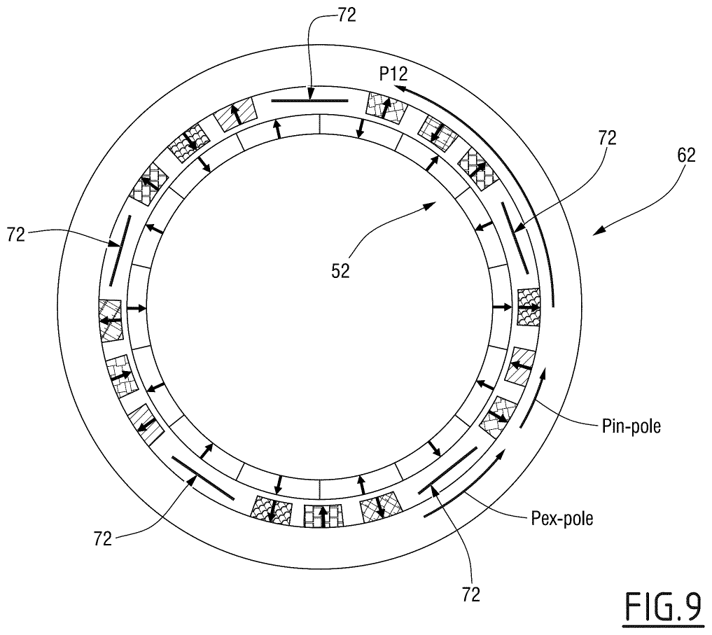

FIG. 9 illustrates another example of embodiment of the rotation ring 62 of the fixed body 22 which can be combined with the rotation ring 52 of the movable body 21, as explained hereinabove. According to said example, the rotation ring 62 of the fixed body 22 also comprises 5 groups of 3 elementary parts. As in the preceding case, the groups are spaced apart by the angular pitch P12 which is e.g. substantially equal to same described in relation to FIG. 7.

Contrary to the preceding case, the pitches P22 and P32 within each of the M2 groups are suitable so that the set of elementary parts 62-1 to 62-K2*M2 form M2 geometrical groupings or poles, each pole comprising K2 elementary parts belonging to different groups. Unlike groups, no elementary part belonging to one pole is placed between two elementary parts belonging to another pole. Within the same pole, the elementary parts are thus grouped geometrically whereas within the same group, the elementary parts can be arranged over the entire available length. Advantageously, there are as many poles as there are groups.

Furthermore, the poles are equally spaced from each other by the angular distance P_{ex_pole} along the circumferential direction. Within each pole, the elementary parts are also equally spaced from each other by the angular distance P_{in_pole}. The latter distance P_{in_pole} is strictly shorter than the spacing distance P_{ex_pole} between the poles.

To this end, each pitch P22 is equal e.g. to 2π/3 and each pitch P32 is equal e.g. to 4π/3. According to said example, the magnetic detectors 72 are placed in the gaps between the poles. In some examples, the elementary parts within each pole can be arranged side by side, without forming gaps therebetween.

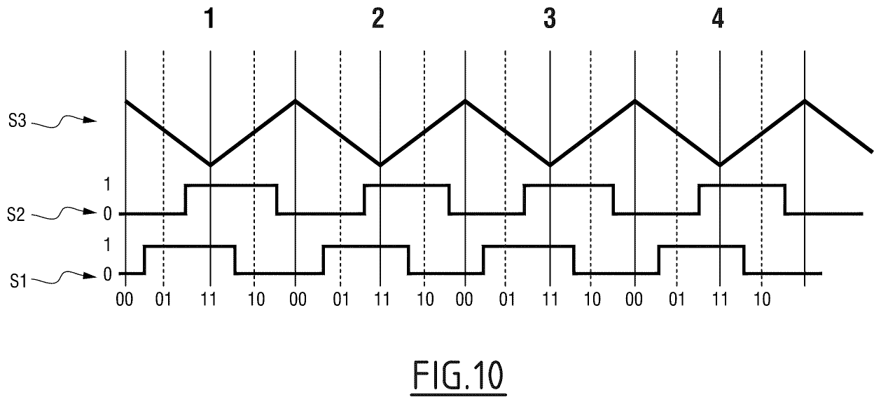

FIG. 10 illustrates an encoding patten created by at least one pair of magnetic detectors of translation 71 or of rotation 72. According to such pattern, one of the magnetic detectors of the pair delivers either a true or a false signal during the movement of the corresponding ring. The signal is denoted by the reference S1 in FIG. 10. The other detector delivers a signal S2 which is offset with respect to the signal S1 by a fraction of the notch pitch. The signal S2 is also composed of true and false values which then alternate with the movement of the corresponding ring along the corresponding direction. Finally, FIG. 10 also shows a plot S3 which corresponds to the notching force or torque provided during the movement of the corresponding ring along the corresponding direction. The plot S3 is then also periodic.

### Second Embodiment

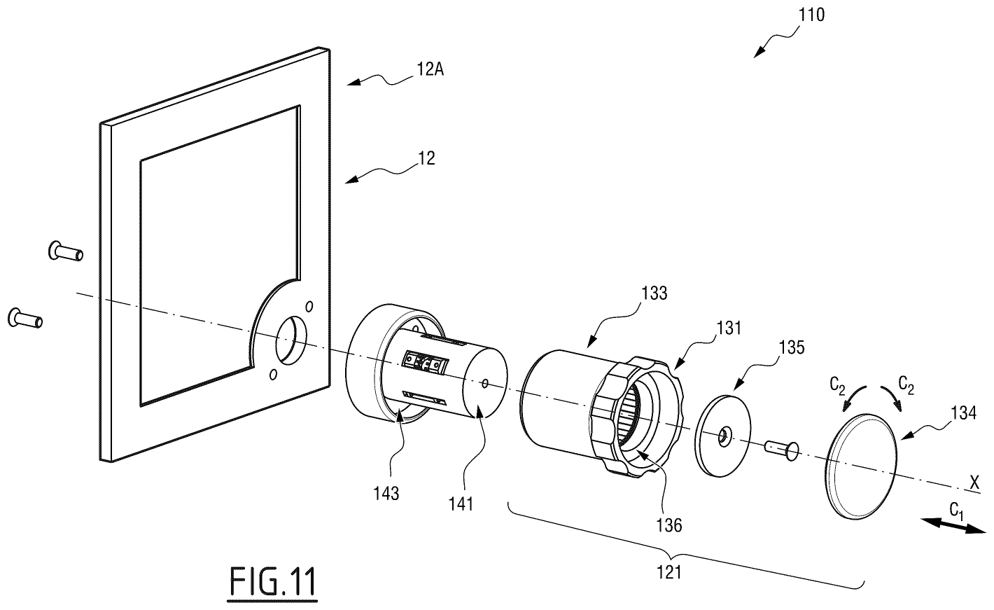

The encoder 110 according to a second embodiment will henceforth be explained with reference to FIG. 11. The application of the encoder 110 is e.g. identical to the application of the encoder 10, as explained hereinabove.

The main difference of the encoder 110 according to the second embodiment consists in the manner of the arrangement thereof with respect to the panel 12. Indeed, as illustrated in FIG. 11, the encoder 110 according to the second embodiment is arranged entirely in the front part 12A of the panel 12.

As illustrated in FIG. 13, just like the encoder 10 according to the first embodiment, the encoder 110 according to the second embodiment comprises a movable body 121, also called first body, and a fixed body 122, also called second body.

The fixed body 122 is attached e.g. directly to the front part 12A of the panel 12. Like in the previous case, the fixed body 122 comprises a support 141 receiving the functional internal elements of the fixed body 122 as will be explained thereafter in greater detail. The support 141 can further comprise a mechanical stop 143 integrated in one of the ends thereof.

Like in the previous case, the movable body 121 further comprises a button 131 and a rotor 133 which is e.g. rigidly attached to the button 131 arranged at the end thereof. The same end of the rotor 133 is e.g. closed by a cover 134 having a surface oriented towards the operator. The cover 134 is linked to the rotor 133. A washer 135 is rigidly attached to the fixed body 122 at the end thereof. The washer 135 can have a mechanical stop during the rotation or the translation of the movable body 121. The mechanical stop can be damped via a return spring or an elastomer part (example of material: EPDM). Moreover, such stop can also be magnetic. In such case, the stop can be produced by placing a magnet rigidly attached to the fixed body, repulsive and opposite with regard to a magnet rigidly attached to the movable body. The magnetic stop is intrinsically damped. Such magnetic stop can be independent or be part of one of the rings 51, 52, 151 or 152 (in a logic of optimization of the number of parts). For example, in the case of a ring of the movable body using a Halbach arrangement, a magnet of the fixed body can be placed so as to be repulsive and opposite the end of the ring having, locally, an axial or a circumferential magnetization. Furthermore, at each of the ends thereof, the rotor 133 can have bearings 136 intended for cooperating with the fixed body 122 in order to ensure the movement of the movable body 121 along each of the directions of encoding, namely, a first direction of encoding C1 corresponding to the direction of translation along the axis X of the encoder and a second direction of encoding C2 corresponding to the direction of rotation about the axis X of the encoder, in the example of the figures.

Contrary to the preceding case, the rotor 133 is intended for incorporating the fixed body 122 at least partially. In other words, the rotor 133 is intended to be arranged around the support 141.

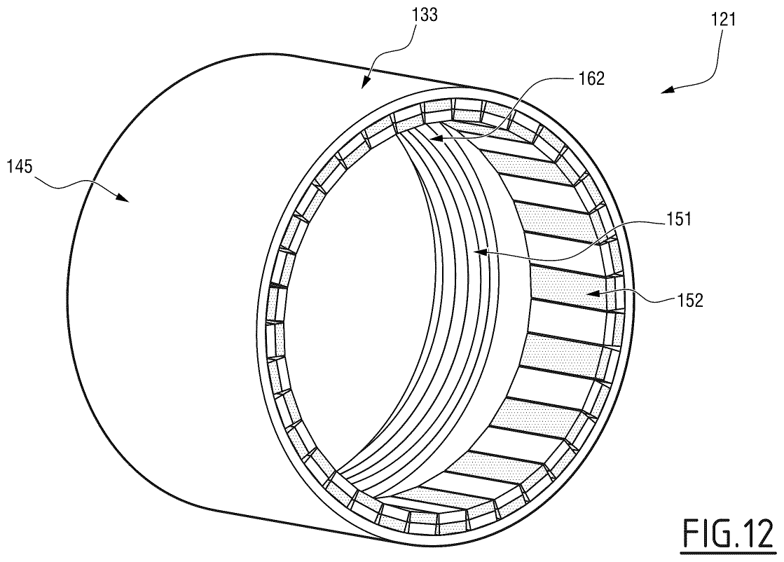

As illustrated in FIG. 12, just like in the previous case, the movable body 121 comprises a translation ring 151, also called first ring, and a rotation ring 152, also called second ring. The rings are similar to the rings 51, 52, respectively, as described above. Unlike the previous case, the rings 151, 152 according to the second embodiment are arranged on an inner surface of the rotor 133 which then has a hollow rotary shaft according to the example of said figure. Each of the rings 151, 152 is attached on the shaft 145 along the axis X of the encoder and stays spaced from the other ring 151, 152.

Also, in a similar manner to the preceding case, the fixed body 122 comprises a plurality of magnetic detectors, a rotation ring and a translation ring (not shown in the figures). Unlike the preceding case, the translation ring of the fixed body 122 with the corresponding detectors are arranged in the internal part of the translation ring 151 of the movable body 121 and the rotation ring of the fixed body 122 with the corresponding detectors are arranged in the internal part of the rotation ring 152 of the movable body 121.

In other words, according to said embodiment, the functional internal elements of the fixed body 122 are arranged on an outer surface of the support 141. Thereby, according to said embodiment, such elements are arranged facing the inner surfaces of the corresponding rings 151, 152. In other words again, according to said embodiment, the functional internal elements of the fixed body 122 are received inside the rings 151, 152, while remaining at a distance from same. The operation and the respective arrangement of these internal elements are similar to same described hereinabove in relation to the first embodiment.

### Other Embodiments

Many other embodiments are also possible. More particularly, all the features described hereinabove in relation to the fixed body (in particular in relation to the translation and/or rotation rings of the fixed body) can also be applied to the movable body. In such case, the fixed body may comprise the characteristics described in relation to the movable body in the preceding embodiments.

Moreover, it is clear that the variable pitch explained in relation to the rings/elementary parts can only be applied to one of the translation or rotation rings. In such case, a homogeneous pitch can be applied to the rings/elementary parts of the other ring to obtain a notching along the desired direction of encoding. Moreover, any other means of achieving such a notching is also possible. Finally, only one direction of encoding can be provided with a notch.

1. An incremental magnetic encoder defining an encoder axis and comprising a fixed body and a body movable with respect to the fixed body along at least one direction of encoding;
one of the bodies, called first body, comprising:
a first support comprising N magnetic elements arranged along the direction of encoding according to a homogeneous pitch PO and defining a magnetic alternation along the direction;
the other body, called second body, comprising:
a second support comprising K*M magnetic elements arranged inhomogeneously along the direction of encoding opposite the N magnetic elements, the K*M magnetic elements forming M groups of K magnetic elements, each of the M groups comprising an initial magnetic element of said group, the initial elements of the M different groups being spaced from each other along the direction of encoding according to a homogeneous pitch P1, the K−1 magnetic elements of each group being spaced from the initial magnetic element of said group according to variable pitches Pi looped back over a predetermined extent along the direction of encoding;
at least one magnetic detector arranged opposite the first support and configured for quantifying each movement of the movable body along the direction of encoding, wherein, within each group, the magnetic elements are uniformly spaced from each other.

2. The encoder according to claim 1, wherein the second body comprises M magnetic detectors, each magnetic detector being configured to quantify each movement of the movable body along the direction of encoding.

3. The encoder according to claim 1, wherein the or each magnetic detector is arranged on the second support in a gap formed between two groups of K magnetic elements.

4. The encoder according to claim 1, wherein the M groups of K magnetic elements define the same variable pitches Pi.

5. The encoder according to claim 1, wherein each variable pitch Pi is defined according to the following relation:
$$Pi = {k}_{i} \frac{L}{N}$$
where
L is said predetermined range;
kᵢ is a natural number chosen to be different for each variable pitch.

6. The encoder according to claim 1, wherein at least one magnetic element of one of the M groups of K magnetic elements is arranged between two magnetic elements of another group of K magnetic elements.

7. The encoder according to claim 1, wherein the second body is the fixed body.

8. The encoder according to claim 1, wherein the direction of encoding corresponds to a translation along the encoder axis or to rotation about the encoder axis.

9. The encoder according to claim 1, wherein the movable body is movable relative to the fixed body furthermore along an additional direction of encoding perpendicular to said direction of encoding.

10. The encoder according to claim 9, wherein the first body and the second body comprise a plurality of additional magnetic elements arranged along the additional direction of encoding on the two bodies at least partially facing each other.
